(19) United States
(12) Patent Application Publication
(10) Pub. No.: US 2025/0003552 A1
(43) Pub. Date: Jan. 2, 2025

(54) Fiber-Reinforced Plastic Tank

(71) Applicant: South Star Technology Limited, Birkirkara (MT)

(72) Inventor: Jared Cuneo, Cedar Park, TX (US)

(73) Assignee: South Star Technology Limited, Birkirkara (MT)

(21) Appl. No.: 18/760,797

(22) Filed: Jul. 1, 2024

Related U.S. Application Data
(60) Provisional application No. 63/523,940, filed on Jun. 29, 2023.

(51) Int. Cl. F17C 1/08

(52) U.S. Cl. CPC F17C 1/08; F17C 2201/0109; F17C 2203/012; F17C 2203/0624; F17C 2203/067; F17C 2203/0673; F17C 2209/2163; F17C 2209/232

(57) ABSTRACT

A method of forming a fiberglass reinforced plastic storage tank includes providing a rotating mandrel having a base layer disposed around an outer surface of the rotating mandrel such that the base layer rotates with the rotating mandrel; and forming a reinforcement layer having a plurality of fiberglass ribs disposed along a length of the base layer, the forming step including using a continuous filament winding process to form the plurality of fiberglass ribs along the length of the base layer in a continuous helical pattern.

### CROSS REFERENCE TO RELATED APPLICATION

This application claims priority to co-pending U.S. Provisional Application Ser. No. 63/523,940 filed Jun. 29, 2023, entitled “Fiber-Reinforced Plastic Tank.” the entire contents of which being incorporated herein by reference.

### FIELD

This disclosure relates to the field of fiberglass storage tanks. More particularly, this disclosure relates to fiberglass storage tanks having continuously wound fiberglass supporting ribs for enhanced strength and support.

### BACKGROUND

Fiberglass-reinforced plastic (FRP) tanks are the new industry standard for storage tanks. FRP tanks combine the corrosive resistance of a plastic tank with durable, lightweight, and easily manufactured fiberglass, providing benefits far and above more expensive metal tanks. FRP tanks can be used for virtually any purpose including storage of water, food products, chemicals, wastewater, petroleum, and more.

Current FRP tanks typically include a structural layer of chopped fiberglass. However, chopped fiberglass is fragmented, which often results in weak points or inconsistencies in the structure that leads to leaks. As a result, current FRP tanks may be prone to damage at several points in the transportation and installation processes, such as during loading, unloading, and the excavation and burial processes. The conventional solution to reducing the possibility of damage is providing the tank with structural reinforcements such as stiff, hollow-core cardboard or plastic ribs wound around the tank. Conventional structural reinforcements come at a cost, however. In particular, cardboard or plastic rim formation significantly increases the production time for the FRP tank. In some cases, the structural reinforcements may also create pressure points on the inside of a tank, which in turn may compromise the integrity of the tank resulting in potential failure.

Accordingly, what is needed is a way to construct and reinforce FRP tanks that prevents damage, enhances strength, avoids typical complications that come with conventional structural reinforcements, and streamlines productivity. Additionally, the construction of the FRP tank would ideally be inexpensive, require reduced maintenance, and general lower lifetime cost than traditional FRP tanks.

### SUMMARY

The above and other needs are met by a fiberglass reinforced plastic storage tank comprising a base layer, a reinforcement layer, and a primary out wall layer. The reinforcement layer includes a plurality of fiberglass ribs disposed along a length of the base layer, each of the plurality of fiberglass ribs connected using a continuous filament winding process such that the plurality of fiberglass ribs are formed along the length of the base layer in a continuous helical pattern. The primary outer wall layer is disposed over the reinforcement layer and base layer.

According to certain embodiments, the plurality of fiberglass ribs are cured to the base layer.

According to certain embodiments, the base layer is in the form of a cylindrically shaped tube.

According to certain embodiments, the continuous helical pattern includes the plurality of fiberglass ribs each forming a raised ring around the base layer and a plurality of joining members each disposed between and joining adjacent raised rings. In some embodiments, each of the raised rings are disposed about twenty-four inches to about thirty-six inches between adjacent raised rings. In some embodiments, the raised rings include a greater thickness than the plurality of joining members.

According to certain embodiments, the fiberglass reinforced plastic storage tank further includes a secondary outer wall layer disposed over the primary outer wall layer and an interstice layer disposed between the primary outer wall layer and the secondary outer wall layer.

According to another embodiment of the disclosure, a method of forming a fiberglass reinforced plastic storage tank includes: providing a rotating mandrel having a base layer disposed around an outer surface of the rotating mandrel such that the base layer rotates with the rotating mandrel; and forming a reinforcement layer having a plurality of fiberglass ribs disposed along a length of the base layer, the forming step including using a continuous filament winding process to form the plurality of fiberglass ribs along the length of the base layer in a continuous helical pattern.

According to certain embodiments, the method further includes forming a primary outer wall layer over the reinforcement layer and base layer during the same continuous filament winding process. According to some embodiments, the method further includes curing the reinforcement layer to the base layer prior to forming the primary outer wall layer.

According to certain embodiments, the forming step further includes: continuously winding fiberglass filaments from a fiber placement head over a first area of the base layer to form a first fiberglass rib of the plurality of fiberglass ribs; advancing the fiber placement head from the first area of the base layer to a second area to of the base layer while continuously winding the fiberglass filaments from the fiber placement head; and continuously winding fiberglass filaments from the fiber placement head over the second area to form a second fiberglass rib of the plurality of fiberglass rims adjacent to the first fiberglass rib. According to some embodiments, the step of advancing the fiber placement head from the first area to the second area forms a joining member that joins the first fiberglass rib to the second fiberglass rib in the continuous helix pattern. In some embodiments, the first fiberglass rib and the second fiberglass rib include a greater thickness than the joining member. In some embodiments, the first fiberglass rib and the second fiberglass rib are disposed about twenty-four inches to about thirty-six inches between adjacent raised rings.

### BRIEF DESCRIPTION OF THE DRAWINGS

Further advantages of the disclosure are apparent by reference to the detailed description in conjunction with the figures, wherein elements are not to scale so as to more clearly show the details, wherein like reference numbers indicate like elements throughout the several views, and wherein:

FIG. 1 depicts a side perspective view of fiberglass reinforced plastic storage tank according to one embodiment of the disclosure.

FIG. 2 depicts a cross-sectional view of the layers of a fiberglass reinforced plastic storage tank according to one embodiment of the disclosure.

FIG. 3 depicts the process step of continuously winding fiberglass filaments from a fiber placement head of a filament winding machine to form a reinforcement layer of a fiberglass reinforced plastic storage tank according to one embodiment of the disclosure.

FIG. 4 depicts a reinforcement layer applied to a base layer of a fiberglass reinforced plastic storage tank according to one embodiment of the disclosure.

FIG. 5 depicts the process step of continuously winding fiberglass filaments from a fiber placement head of a filament winding machine to form a primary outer wall layer over the reinforcement layer and the base layer of a fiberglass reinforced plastic storage tank according to one embodiment of the disclosure.

### DETAILED DESCRIPTION

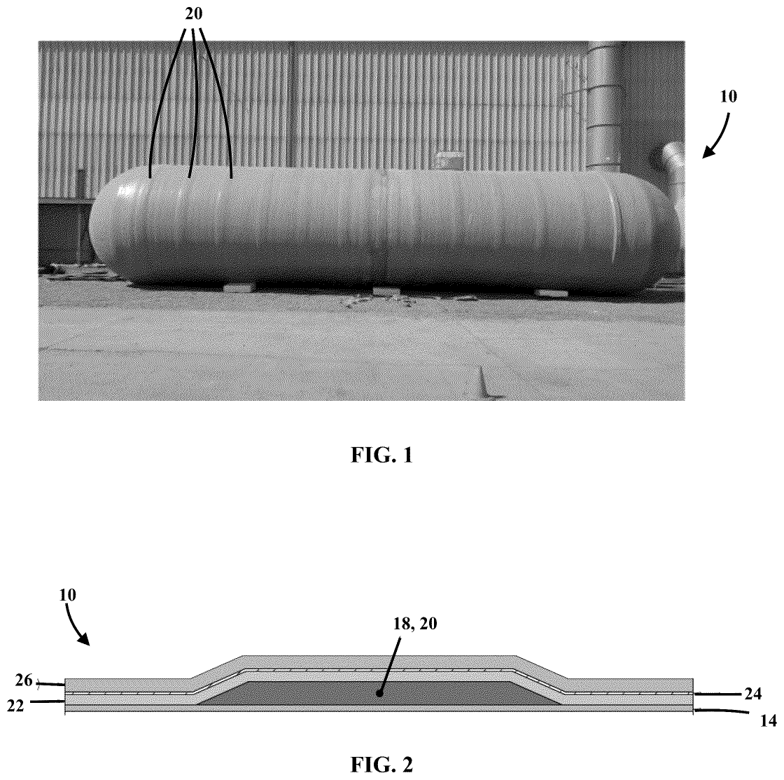

With reference to FIG. 1, disclosed herein is an improved FRP tank 10 having a reinforcement layer including a plurality of fiberglass ribs 20 disposed along the length of the tank 10. As will be described herein, the fiberglass ribs 20 of the reinforcement layer are formed using a continuous filament winding process such that the ribs are formed along the length of a base layer in a continuous helical pattern. The improved tanks exhibit greater primary strength and stiffness and significantly less deflection than FRP tanks produced via either chopped fiberglass or a continuous filament winding processes but without helically wound fiberglass ribs formed in an interior reinforcement layer. The helically wound fiberglass ribs formed using the continuous filament winding process further reduce the rib formation time as compared to standard carboard or plastic rib formation techniques.

With reference to FIG. 2, a cross-sectional view of the layers of an FRP tank 10 is depicted. The tank 10 generally includes a base layer 14, a reinforcement layer 18 having the fiberglass ribs 20, a first primary outer wall layer 22 formed over the base layer 14 and reinforcement layer 18, an interstitial layer 24 formed over the primary outer wall layer 22, and a secondary outer wall layer 26 formed over the interstitial layer 24.

The FRP tank 10 disclosed herein is preferably produced in large part using a continuous filament winding process (i.e., filaments under tension being applied by a filament fiber placement head to form layers of the tank disposed on a rotating mandrel). The steps in the continuous filament winding process may be controlled by computer numerical control (CNC) machining in which the pattern of the filament fiber placement head is CNC controlled based on desired thicknesses and/or positioning of the various layers described herein.

In one embodiment, the method for producing the improved FRP tank 10 begins with the base layer 14 being applied to a steel mandrel such as via fiberglass chopping. The base layer 14 is preferably an inner polymer liner for providing corrosion resistance to the interior of the tank 10. The inner polymer liner may comprise various materials corresponding to the level of corrosion resistance and/or mechanical resistance required by an application, including polyester (e.g., isophthalic polyester resins), vinyl ester, and epoxy resins, and other resins not mentioned with similar suitable characteristics. An exemplary base layer 14 is formed of Owens Corning® 495 roving. The thickness of the base layer 14 in preferred embodiments is about .1 to about .13 inches.

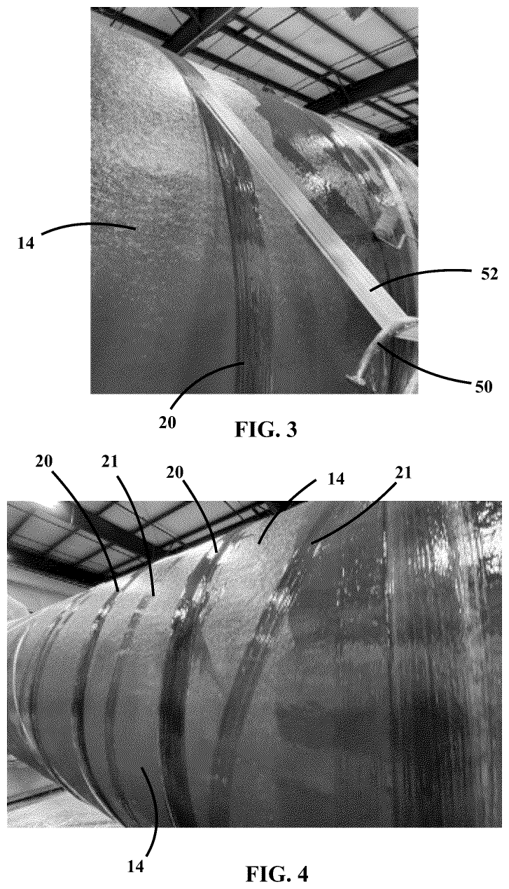

After the base layer 14 is formed around the mandrel, the reinforcement layer 18 is formed over the base layer 14 in a continuous filament winding process while the mandrel is rotated. With reference to FIGS. 3-4, the filament fiber placement head 50 of the continuous filament winding equipment applies fiberglass filaments 52 with high glass content (as compared to the polymer of the inner base layer) to the base layer 14. More specifically, the fiberglass filaments 52 are wound onto the base layer 14 while rotating the mandrel. By virtue of the filament winding process, the fiberglass filaments 52 are secured to the base layer 14 via fiber tension and chemical bonding in a pattern controlled by the movement of the filament fiber placement head 50. The filament fiber placement head 50 is preferably moved in a CNC pattern for forming a plurality of fiberglass ribs 20 along a length of the base layer 14 in a continuous helical pattern. The fiberglass ribs 20 impart significantly improved strength and rigidity to the base layer 14 by virtue of a high clastic modulus of the rib material and connected helical winding pattern of the ribs 20.

As shown best with respect to FIGS. 1-2, the fiberglass ribs 20 are preferably in the form of raised rings disposed at intervals along the length of the base layer 14. With reference back to FIGS. 3-4, as a result of the continuous filament winding process used to form the fiberglass ribs 20, the reinforcement layer 18 further includes a plurality of joining members 21 each disposed between and connecting adjacent ribs 20. In preferred embodiments, the fiberglass ribs 20 are formed by winding the fiberglass filaments 52 multiple times over the same general area of the base layer 14 creating the raised rings and providing further support to the inner polymer liner. Depending on method of application, the cross section of the fiberglass ribs 20 may take various configurations including trapezoidal/tapered (shown above), rounded, squared, or other shapes. The joining members 21 are formed as the filament fiber placement head 50 moves along the base layer 14 to the desired area for the next adjacent fiberglass rib 20. Thus, the thickness of the joining members 21 is typically limited to the thickness of the filaments 52 used. On the other hand, the thickness of the ribs 20 is dependent on both the thickness of the filaments 52 used and the number of windings around the base layer 14 used to form the rib 20. In preferred embodiments, the thickness of each rib 20 is about .4 inches to about .5 inches.

The following example is illustrative of the reinforcement layer 18 formation process. The raised ring structure of a first fiberglass rib 20 is formed by continuously winding fiberglass filaments 52 from a filament fiber placement head 50 over a first area of the base layer 14. More specifically, the filament fiber placement head 52 is maintained in the same first general area with respect to the base layer 14 while the mandrel is rotated a certain number of revolutions to create a desired thickness and configuration of the first fiberglass rib 20. Once the first fiberglass rib 20 is formed as desired, the filament fiber placement head 52 advances from the first area to a second area of the base layer 14 a certain distance while fiberglass filaments 52 are still continuously being wound from the filament fiber placement head 52 and the mandrel is being rotated such that a joining member 21 is formed. After the filament fiber placement head 52 is advanced the desired distance to the second area of the base layer 14, the raised ring structure of a second fiberglass rib 20 is formed by continuously winding fiberglass filaments 52 from a filament fiber placement head 50 stationary over the second area of the base layer 14. This process is repeated as needed/desired to form any number of ribs 20 such that the continuous helical pattern is produced for the reinforcement layer 18.

In preferred embodiments, the ribs are spaced about 24 to about 36 inches apart along the length of the tank 10 in order to provide sufficient space to create openings in the tank 10 for the introduction of monitoring equipment, manways/manholes, and the like.

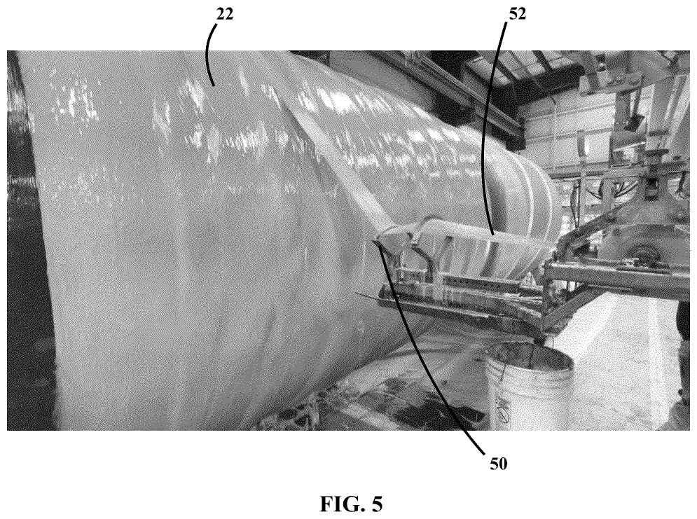

Once the reinforcement layer 18 is complete and the fiberglass ribs 20 have cured to the base layer 14, the primary outer wall layer 22 is formed over the reinforcement layer 18 and base layer 14. The primary outer wall layer is the primary structural wall of the FRP tank 10 that is intended to bear most of the load applied to the tank 10. In preferred embodiments, the primary outer wall layer 22 is formed using the same continuous filament winding equipment as used to form the reinforcement layer 18 (i.e., the base layer 14 and reinforcement layer 18 are maintained on the same mandrel until it is time to form the primary outer wall layer 22 via the same filament fiber placement head 50 as used to form the reinforcement layer 18) but with a tighter, overlapping helical pattern as depicted in FIG. 5. By virtue of the tension under which the filaments 52 of the primary outer wall layer 22 are applied, the primary outer wall layer 22 further compacts the base layer 14 and reinforcement layer 18 and ensures the contact points between the ribs 20 and the base layer 14 will not be compromised. In preferred embodiments, the primary outer wall layer includes a thickness of about .2 inches to about .25 inches.

In certain embodiments, the primary outer wall layer 22 and reinforcement layer 18 are formed from filaments 52 having the same composition of resin and fiberglass materials. In certain embodiments, the outer wall layer 22 and reinforcement layer 18 are formed from Owens Corning® 366 roving.

Following formation of the primary outer wall layer 22, the interstitial layer 24 is applied around primary outer wall layer 22. According to certain embodiments, the interstitial layer 24 is achieved by wrapping the primary outer layer 22 with one or more alternating layers of mylar liner and netting that may be applied either manually or using an automated carriage. The secondary outer wall layer 26 is then formed over the interstitial layer 24. According to certain embodiments, the secondary outer wall layer 26 is formed from the same material and in the same manner as the base layer 14 for providing corrosion resistance to the outside of the tank 10. According to preferred embodiments, the thickness of the interstitial layer 24 is about .025 inches to about .050 inches while the thickness of the secondary outer wall layer is about .25 inches to about .35 inches.

After the tank 10 is formed (or after formation of the primary outer wall layer 22 if desired), the newly formed FRP tank 10 is demolded from the mandrel and any additional processing steps may be applied.

In addition to varying the composition of the materials for the different layers, the thicknesses of the layers may be varied depending on the desired corrosion resistance and mechanical resistance. One significant benefit of the improved FRP tank 10 and related method is that the reinforcement layer 18 and primary outer wall layer 22 are able to be fabricated almost entirely using CNC without the need to interrupt the process or change materials for the filament winding process. The result is a stronger tank and shorter manufacturing times.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by any claims when interpreted in accordance with the breadth to which they are fairly, legally, and equitably entitled.

What is claimed is:

1. A fiberglass reinforced plastic storage tank comprising:
a base layer;
a reinforcement layer having a plurality of fiberglass ribs disposed along a length of the base layer, each of the plurality of fiberglass ribs connected using a continuous filament winding process such that the plurality of fiberglass ribs are formed along the length of the base layer in a continuous helical pattern; and
a primary outer wall layer disposed over the reinforcement layer and base layer.

2. The fiberglass reinforced plastic storage tank of claim 1 wherein the plurality of fiberglass ribs are cured to the base layer.

3. The fiberglass reinforced plastic storage tank of claim 1 wherein the base layer is in the form of a cylindrically shaped tube.

4. The fiberglass reinforced plastic storage tank of claim 1 wherein the continuous helical pattern includes the plurality of fiberglass ribs each forming a raised ring around the base layer and a plurality of joining members each disposed between and joining adjacent raised rings.

5. The fiberglass reinforced plastic storage tank of claim 4 wherein each of the raised rings are disposed about twenty-four inches to about thirty-six inches between adjacent raised rings.

6. The fiberglass reinforced plastic storage tank of claim 4 wherein the raised rings include a greater thickness than the plurality of joining members.

7. The fiberglass reinforced plastic storage tank of claim 1 further comprising a secondary outer wall layer disposed over the primary outer wall layer and an interstice layer disposed between the primary outer wall layer and the secondary outer wall layer.

8. A method of forming a fiberglass reinforced plastic storage tank, the method comprising:
providing a rotating mandrel having a base layer disposed around an outer surface of the rotating mandrel such that the base layer rotates with the rotating mandrel; and
forming a reinforcement layer having a plurality of fiberglass ribs disposed along a length of the base layer, the forming step including using a continuous filament winding process to form the plurality of fiberglass ribs along the length of the base layer in a continuous helical pattern.

9. The method of claim 8 further comprising forming a primary outer wall layer over the reinforcement layer and base layer during the same continuous filament winding process.

10. The method of claim 9 further comprising curing the reinforcement layer to the base layer prior to forming the primary outer wall layer.

11. The method of claim 8 wherein the forming step further includes:
continuously winding fiberglass filaments from a fiber placement head over a first area of the base layer to form a first fiberglass rib of the plurality of fiberglass ribs;
advancing the fiber placement head from the first area of the base layer to a second area to of the base layer while continuously winding the fiberglass filaments from the fiber placement head; and
continuously winding fiberglass filaments from the fiber placement head over the second area to form a second fiberglass rib of the plurality of fiberglass rims adjacent to the first fiberglass rib.

12. The method of claim 11 wherein the step of advancing the fiber placement head from the first area to the second area forms a joining member that joins the first fiberglass rib to the second fiberglass rib in the continuous helix pattern.

13. The method of claim 12 wherein the first fiberglass rib and the second fiberglass rib include a greater thickness than the joining member.

14. The method of claim 13 wherein the first fiberglass rib and the second fiberglass rib are disposed about twenty-four inches to about thirty-six inches between adjacent raised rings.
